(19) United States
(12) Patent Application Publication
(10) Pub. No.: US 2016/0350581 A1
(43) Pub. Date: Dec. 1, 2016

(54) Smart Ring with Biometric Sensor

(71) Applicant: SanDisk Technologies Inc., Plano, TX (US)

(72) Inventors: Biju Manuel, Kannur (IN); Sujeeth Joseph, Bangalore (IN)

(73) Assignee: SanDisk Technologies Inc., Plano, TX (US)

(21) Appl. No.: 14/727,527

(22) Filed: Jun. 1, 2015

(51) Int. Cl. G06K 9/00; A44C 9/00

(52) U.S. Cl. CPC G06K 9/00087; A44C 9/0053; G06K 9/00013

(57) ABSTRACT

A ring with a biometric sensor is provided. In one embodiment, the ring comprises a ring body, a biometric sensor positioned in the ring body and configured to sense a biometric feature, a memory configured to store a biometric feature of an authorized user, and a controller. The controller is configured to determine whether the biometric feature sensed by the biometric sensor matches the biometric feature stored in the memory, and in response to determining that the biometric feature sensed by the biometric sensor matches the biometric feature stored in the memory, enable a function of the ring.

### BACKGROUND

Wearable technology, such as a smart ring, is becoming more and more popular as a fashion accessory that also provides electronic function(s). For example, depending on its features, a smart ring can serve as a remote extension of a user's smartphone or other computing device (e.g., tablet), alerting a user of incoming calls, texts, or emails, providing updates from social media sites, and acting as a remote control of various functions (e.g., controlling music playback and volume, triggering the camera, etc.).

### BRIEF DESCRIPTION OF THE DRAWINGS

FIG. 1A is a diagram of a smart ring of an embodiment where the biometric sensor is contoured along an inside surface of a ring body.

FIG. 1B is a diagram of a smart ring of an embodiment where the biometric sensor is contoured along an outside surface of a ring body.

FIG. 2 is a block diagram of a printed circuit board of an embodiment.

FIG. 3 is a flow chart of a method of an embodiment for enabling a function of a smart ring.

FIGS. 4A-4E are illustrations showing a smart ring of an embodiment positioned along different parts of a user's finger.

FIG. 5 is an illustration showing different segments of a user's finger with respect to a smart ring of an embodiment.

FIG. 6 is a flow chart of a method of an embodiment for enabling a function of a smart ring.

FIG. 7 is a flow chart of a method of an embodiment for disabling a function of a smart ring.

### DETAILED DESCRIPTION OF THE PRESENTLY PREFERRED EMBODIMENTS

By way of introduction, the below embodiments relate to a ring with a biometric sensor. In one embodiment, the ring comprises a ring body, a biometric sensor positioned in the ring body and configured to sense a biometric feature, a memory configured to store a biometric feature of an authorized user, and a controller. The controller is configured to determine whether the biometric feature sensed by the biometric sensor matches the biometric feature stored in the memory, and in response to determining that the biometric feature sensed by the biometric sensor matches the biometric feature stored in the memory, enable a function of the ring.

In some embodiments, the biometric sensor is further configured to sense whether the ring is being inserted onto a finger. In some embodiments, the biometric sensor is configured to sense whether the ring is being inserted onto the finger by detecting a tip of the finger and/or whether the ring is being inserted onto the finger by detecting a contour of the finger.

In some embodiments, the biometric sensor is further configured to sense whether the ring is being removed from a finger. In some embodiments, the biometric sensor is configured to sense whether the ring is being removed from the finger by detecting whether the ring was moved past a finger segment.

In some embodiments, the memory is configured to store a plurality of biometric features, each associated with a different function of the ring, wherein the controller is further configured to determine which stored biometric feature matches the biometric feature sensed by the biometric sensor and enable a function associated with the stored biometric feature that matches the biometric feature sensed by the biometric sensor. In some embodiments, the plurality of biometric features are biometric features of different fingers of an individual user or are different segments on a single finger.

In some embodiments, the function of the ring comprises at least one of the following: accessing user data stored in the memory, opening a door, making a payment, authenticating a secure application in a device in communication with the ring, controlling an application in a device in communication with the ring, and receiving an alert from a device in communication with the ring.

In some embodiments, the ring contains one or more of the following: a wireless transceiver, a display device, and a battery (rechargeable or non-rechargable). Also, in some embodiments, the biometric sensor is contoured along an inside surface of the ring body or an outside surface of the ring body. The controller can also be configured to store the biometric feature of the authorized user in the memory during a set-up mode.

In some embodiments, the biometric sensor is configured to sense one or more of the following: a fingerprint, a finger vein, an oxygen saturation level, a pulse, and a heartbeat pattern.

In some embodiments, the memory is a three-dimensional memory.

Other embodiments are possible, and each of the embodiments can be used alone or together in combination. Accordingly, various embodiments will now be described with reference to the attached drawings.

As mentioned in the background section above, wearable technology, such as a smart ring, is becoming more and more popular as a fashion accessory that also provides electronic function(s). For example, depending on its features, a smart ring can serve as a remote extension of a user's smartphone or other computing device (e.g., tablet), alerting a user of incoming calls, texts, or emails (e.g., via vibration, a light, an icon, or a display screen), providing updates from social media sites, and acting as a remote control of various functions (e.g., controlling music playback and volume, triggering the camera, etc. using one or more user input elements on the ring). A smart ring can also provide electronic functions other than being a remote extension of a user's smartphone or other computing device. For example, a smart ring can allow access to secured areas (e.g., unlocking a locked door) or can act as a remote control of other electronic devices.

However, the functions provided by prior smart rings are “possession based,” meaning that any person who possesses the smart ring will be able to use its function(s), even though the person possessing the ring isn't the owner of the ring. This can have unfortunate consequences. For example, if one of the functions of the ring is to transmit a signal to open a locked door, any person wearing the smart ring (including a person who steals the smart ring from its owner or finds a lost ring) will be able to open the locked door simply because he has possession of the smart ring.

The following embodiments address this problem by equipping a smart ring with a biometric sensor that is configured to sense a biometric feature of a person attempting to use the smart ring. The smart ring compares the sensed biometric feature with a stored biometric feature of an authorized user. If the sensed and stored features match, the function of the smart ring is enabled.

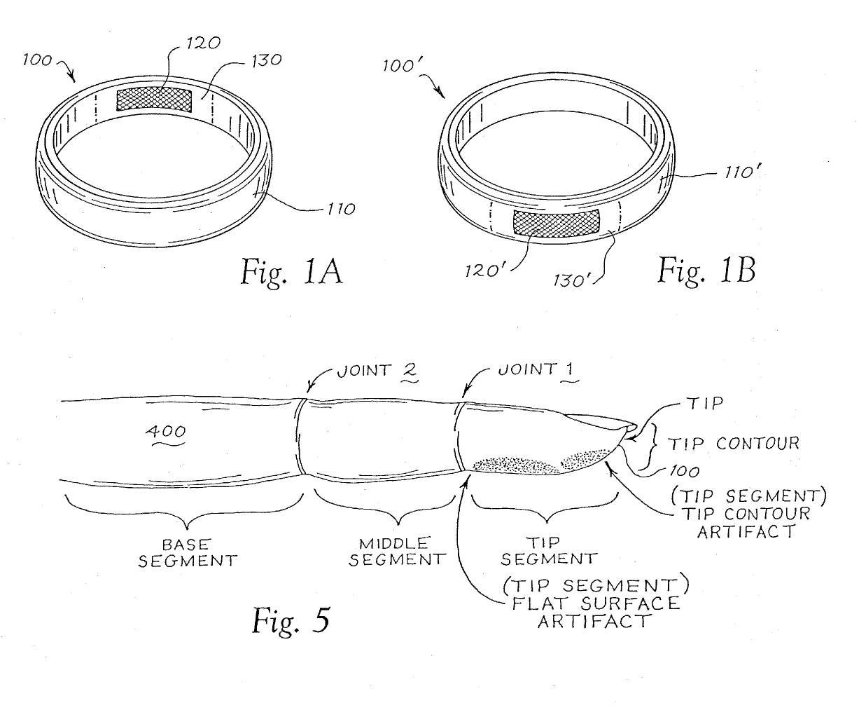

Turning now to the drawings, FIG. 1A is an illustration of a smart ring 100 of an embodiment. As shown in FIG. 1A, the smart ring 100 comprises a ring body 110 and a biometric sensor 120. As used herein, a biometric sensor refers to any suitable device that can sense a biometric feature. In one embodiment, the biometric sensor 120 takes the form of a fingerprint sensor that is configured to sense a fingerprint (e.g., when the ring body is placed over a finger). Examples of other biometric features that can be sensed by the biometric sensor 120 instead of or in addition to a fingerprint include, but are not limited to, a finger vein, an oxygen saturation level (e.g., pulse-oximetry), a pulse, and a heartbeat pattern (e.g., ECG monitoring). Of course, these are merely examples, and other types of biometric sensors can be used to sense other types of biometric features.

The biometric sensor 120 can be placed on any suitable location on the smart ring 100. For example, in the embodiment shown in FIG. 1A, the biometric sensor 120 is contoured along an inside surface of the ring body 110, so the biometric feature can be sensed from a finger when the ring body 110 is placed over that finger. As another example (shown in the smart ring 100′ in FIG. 1B), the biometric sensor 120′ (on printed circuit board 130′) can be contoured along an outside surface of the ring body 110, so the biometric feature can be sensed from one or more fingers gripping the outside surface of the ring body 110′ to position and slide the smart ring over a finger on the opposite hand.

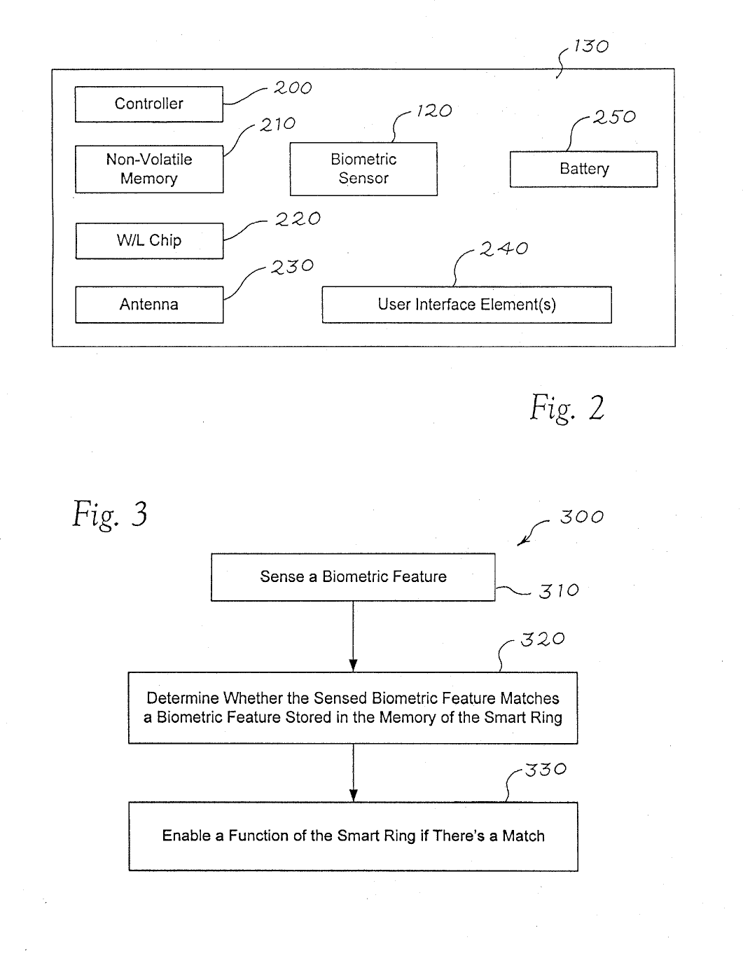

In one embodiment, the biometric sensor 120 is part of a printed circuit board 130 located in the interior of the ring body 110. As shown in FIG. 2, in this embodiment, the printed circuit board 130 comprises a controller 200, non-volatile memory 210, a wireless chip 220, an antenna 230, user interface element(s) 240, and a rechargeable (or non-rechargeable) battery 250, which are all operatively in communication with one another. The “operatively in communication with” could mean directly in communication with or indirectly (wired or wireless) in communication with through one or more components, which may or may not be shown or described herein. It should be noted that these components are merely examples and fewer or more components can be used.

In general, the non-volatile memory 210 is configured to store a biometric feature of an authorized user. The non-volatile memory 210 can include any suitable non-volatile storage medium, including NAND flash memory cells and/or NOR flash memory cells. The memory cells can take the form of solid-state (e.g., flash) memory cells and can be one-time programmable, few-time programmable, or many-time programmable. The memory cells can also be single-level cells (SLC), multiple-level cells (MLC), triple-level cells (TLC), or use other memory cell level technologies, now known or later developed. Also, the memory cells can be fabricated in a two-dimensional or three-dimensional fashion. Additional examples of suitable memory are discussed at the end of this document.

With reference to the flow chart 300 in FIG. 3, the biometric sensor 120 is configured to sense a biometric feature of a user putting on the smart ring 100 (act 310), and the controller 200 is configured to determine whether the biometric feature sensed by the biometric sensor 120 matches the biometric feature stored in the memory 210 (act 320). If there is a match, the controller 200 is configured to enable a function of the smart ring 100 (act 330). The controller 200 can take the form of processing circuitry, a microprocessor or processor, and a computer-readable medium that stores computer-readable program code (e.g., firmware) executable by the (micro)processor, logic gates, switches, an application specific integrated circuit (ASIC), a programmable logic controller, and an embedded microcontroller, for example. The controller 200 can be configured with hardware and/or firmware to perform the various functions described below and shown in the flow diagrams.

As used herein, a “function” of the smart ring 100 can take any suitable form. For example, in some embodiments, the smart ring 100 can have one or more of the following functions (or additional functions): accessing user data stored in a memory of the smart ring, opening a door, making a payment, authenticating a secure application in a device in communication with the smart ring, and controlling an application in or receiving an alert from a device (e.g., smart phone, tablet, computer) in communication with the smart ring. Of course, these are merely examples, and other functions can be used. In another embodiment, the function is simply turning the smart ring 100 on or waking the smart ring 100 up from a sleep mode (where some other functions of the smart ring 100 (e.g., a displayed clock) can still be enabled even though others are not). In one embodiment, the function of the smart ring 200 is performed using the wireless chip 220 and/or the antenna 230 (together referred to as a wireless transceiver (e.g., for near field communications (NFC)) to send and receive communications with an external device, such as a smart phone. The user interface element(s) 240 can be related or unrelated to the function. For example, in one embodiment, the user interface element 240 is a display device that displays the current time irrespective of whether an authorized user is wearing the smart ring 100. As another example, the user interface element 240 can be a buzzer/vibrator, LED light, etc. that provides an authorized user with an alert from a paired smartphone or other device.

There are several advantages associated with these embodiments. For example, because the smart ring 100 of these embodiments enables a function only if the biometric feature sensed by the biometric sensor 120 matches the biometric feature stored in the memory 210, this embodiment avoids the problems of prior “possession based” smart rings. With these embodiments, the function of the smart ring 100 can be enabled only for its true owner. This provides a very valuable security measure that is not present in prior smart rings.

There are many alternatives that can be used with these embodiments. For example, instead of storing a single biometric feature of a user, the smart ring 100 can store a plurality of biometric features of a user, where each biometric feature is associated with a different function of the smart ring 100. For example, fingerprints of two or more of the user's fingers can be stored in the smart ring 100 and associated with different functions. That way, a different function can be enabled depending on which finger the user puts the smart ring 100 on. As another alternative, three-dimensional (i.e., XYZ) functions can be enabled/disabled based on the direction of movement of the smart ring 100 as sensed by movement across finger segments (explained in more detail below). As yet another alternative, the function that is enabled depends on the finger segment that the smart ring 100 is positioned over. For example, if the smart ring 100 is worn on the middle segment, Functions (X to Z) can be enabled, whereas if the smart ring 100 is worn on the base segment, Functions (L to N) can be enabled.

As noted above, any suitable type of biometric sensor 120 and biometric feature can be used. The following paragraphs provide examples of one exemplary embodiment, in which the biometric sensor 120 is a fingerprint sensor, and the biometric feature is a fingerprint. Again, this is merely one example, and the claims should not be limited to this example unless expressly recited therein.

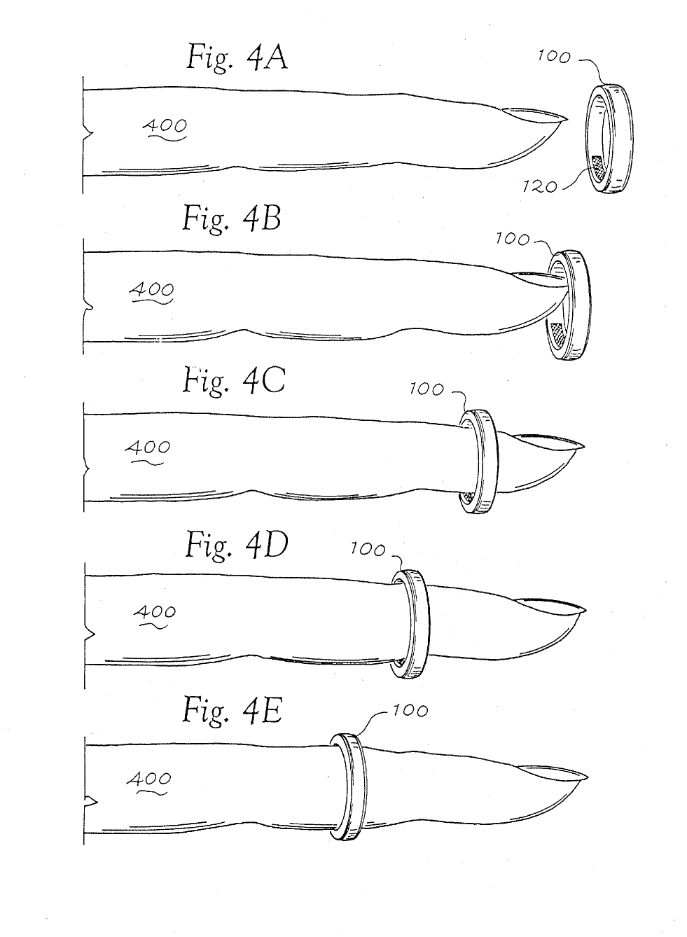

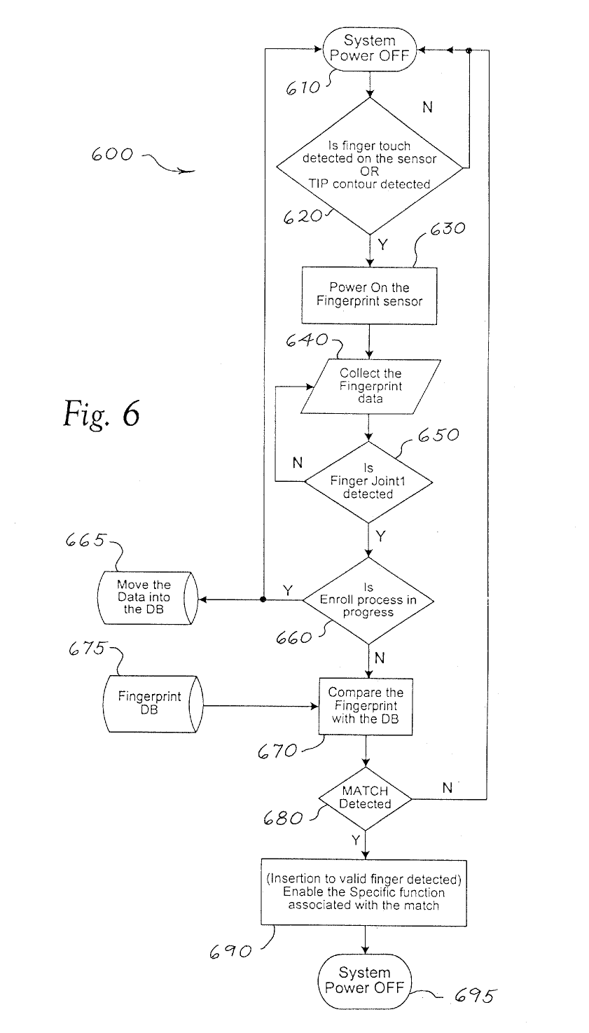

Turning again to the drawings, FIGS. 4A-4E, FIG. 5, and the flow chart 600 in FIG. 6 will be used to illustrate how a fingerprint sensor can enable a function of the smart ring 100. In general, this method uses the fingerprint sensor 120 to sense whether the smart ring 100 is being inserted onto a finger and then senses a fingerprint in response to sensing that the smart ring 100 is being inserted onto the finger. As shown in FIG. 4A and act 610 in the flow chart 600 in FIG. 6, before the smart ring 100 is placed on the user's finger 400, the function of the smart ring 100 (or the entire system of the smart ring 100) is disabled/powered-off. As the ring 100 is slid onto the user's finger 400 (FIG. 4B), the fingerprint sensor 120 detects a finger touch on the sensor 120 or detects the contour of the user's finger 400 (act 620). Based on this detection, the controller 200 powers-on the fingerprint sensor 200 (act 630), so the fingerprint sensor 200 can collect fingerprint data (act 640). As shown in FIG. 4C and FIG. 5, in one embodiment, the fingerprint data is collecting on the tip segment of the user's finger 400, which is between the tip of the finger 400 and the first joint of the finger. This tip segment is a relatively-flat surface from which a user's fingerprint can be detected. The smart ring 100 monitors when the boundary (“joint 1”) between the tip segment and the middle segment is detected (act 650), as that is when the smart ring 100 is past the fingerprint detection zone (see FIGS. 4D and 4E). (The fingerprint detection zone is shown between the dotted lines in FIGS. 4A-4E.) At that point, the controller 200 determines whether the smart ring 200 is in the process of enrolling a user (e.g., during a set-up mode) (act 660). If the smart ring 200 is in the process of enrolling a user, the detected fingerprint is stored in a fingerprint database in the memory 210 as an authorized user (act 665). Otherwise, the controller 200 compares the detected fingerprint with an authorized fingerprint retrieved from the fingerprint database (acts 670 and 675). If a match is detected (act 680), the controller 200 determines that the smart ring 100 was inserted onto the finger of a valid/authorized user, enables the specific function associated with the match, and turns on the system power to perform that function (act 690 and 695).

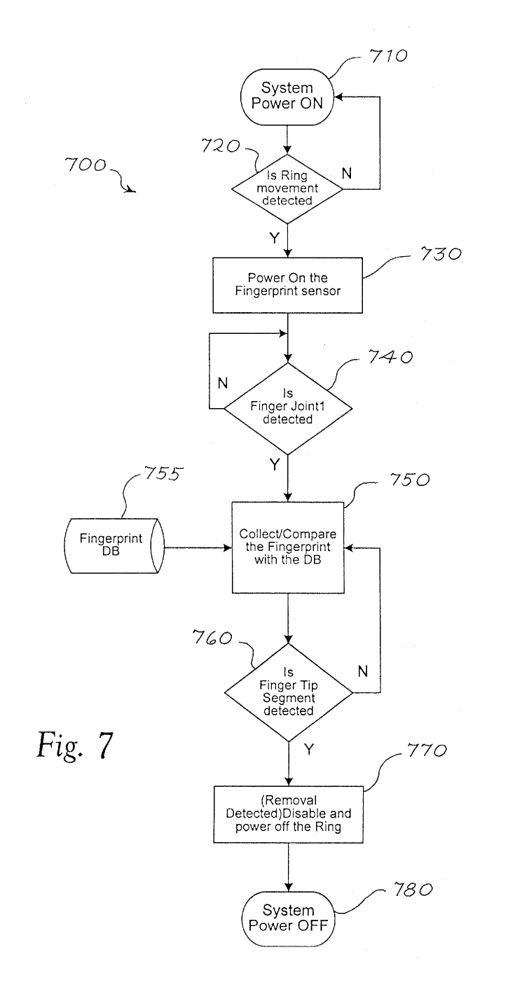

FIG. 7 is a flow chart 700 showing how the function of the smart ring 100 is disabled. In general, the fingerprint detector 120 is configured to sense whether the smart ring 100 is being removed from a finger, so it can disable the previously-enabled function of the smart ring 100. As shown in FIG. 7, the smart ring 100 is on, and the fingerprint sensor 120 monitors for movement of the smart ring 100 along the finger 400, as that would indicate that the user is possibly taking off the smart ring 100. If movement of the smart ring 100 is detected, the controller 200 powers on the fingerprint sensor 120 (act 730) and detects whether “joint 1” (the boundary between the middle segment and the tip segment (see FIG. 5)) is detected (act 740). If it is, the fingerprint sensor 120 detects a fingerprint, and the controller 200 compares the detected fingerprint with the fingerprint stored in the fingerprint database (acts 750 and 755). The controller 200 then determines if the fingertip segment was detected (act 760). If it was, the controller 200 knows that the smart ring 100 was removed from the user's finger 400 and disables the previously-enabled function of the smart ring 100 and powers off the smart ring 100 (acts 770 and 780).

Finally, as mentioned above, any suitable type of memory can be used. Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are exemplary, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and word lines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three dimensional exemplary structures described but cover all relevant memory structures within the spirit and scope of the invention as described herein and as understood by one of skill in the art.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the preferred embodiments described herein can be used alone or in combination with one another.

What is claimed is:

1. A smart ring comprising:
a ring body;
a biometric sensor positioned in the ring body and configured to sense a biometric feature;
a memory configured to store a biometric feature of an authorized user; and
a controller in communication with the biometric sensor and the memory, wherein the controller is configured to:
determine whether the biometric feature sensed by the biometric sensor matches the biometric feature stored in the memory; and
in response to determining that the biometric feature sensed by the biometric sensor matches the biometric feature stored in the memory, enable a function of the smart ring.

2. The smart ring of claim 1, wherein the biometric sensor is further configured to sense whether the smart ring is being inserted onto a finger, and wherein the biometric sensor is configured to sense the biometric feature in response to sensing that the smart ring is being inserted onto the finger.

3. The smart ring of claim 2, wherein the biometric sensor is configured to sense whether the smart ring is being inserted onto the finger by detecting a tip of the finger.

4. The smart ring of claim 2, wherein the biometric sensor is configured to sense whether the smart ring is being inserted onto the finger by detecting a contour of the finger.

5. The smart ring of claim 1, wherein the biometric sensor is further configured to sense whether the smart ring is being removed from a finger, and wherein the controller is further configured to disable the function of the smart ring in response to determining that the smart ring is being removed from the finger.

6. The smart ring of claim 5, wherein the biometric sensor is configured to sense whether the smart ring is being removed from the finger by detecting whether the smart ring was moved past a finger segment.

7. The smart ring of claim 1, wherein the memory is configured to store a plurality of biometric features, each associated with a different function of the smart ring, and wherein the controller is further configured to:
determine which stored biometric feature matches the biometric feature sensed by the biometric sensor; and
enable a function associated with the stored biometric feature that matches the biometric feature sensed by the biometric sensor.

8. The smart ring of claim 7, wherein the plurality of biometric features are biometric features of different fingers of an individual user.

9. The smart ring of claim 7, wherein the plurality of biometric features from different segments on a single finger.

10. The smart ring of claim 1, wherein the function of the smart ring comprises at least one of the following: accessing user data stored in the memory, opening a door, making a payment, authenticating a secure application in a device in communication with the smart ring, controlling an application in a device in communication with the smart ring, and receiving an alert from a device in communication with the smart ring.

11. The smart ring of claim 1 further comprising a wireless transceiver in communication with the controller, wherein the wireless transceiver is configured to perform the function.

12. The smart ring of claim 1 further comprising a display device in communication with the controller.

13. The smart ring of claim 1 further comprising a battery in communication with the controller.

14. The smart ring of claim 1, wherein the biometric sensor is contoured along an inside surface of the ring body.

15. The smart ring of claim 1, wherein the biometric sensor is contoured along an outside surface of the ring body.

16. The smart ring of claim 1, wherein the controller is further configured to store the biometric feature of the authorized user in the memory during a set-up mode.

17. The smart ring of claim 1, wherein the memory is a three-dimensional memory.

18. The smart ring of claim 1, wherein the biometric sensor comprises a fingerprint sensor configured to sense a fingerprint.

19. The smart ring of claim 1, wherein the biometric sensor is configured to sense one or more of the following: a finger vein, an oxygen saturation level, a pulse, and a heartbeat pattern.

20. A method for enabling a function of a smart ring, the method comprising:
performing the following in a smart ring having a biometric sensor:
sensing a biometric feature with the biometric sensor;
determining whether the biometric feature sensed by the biometric sensor matches a biometric feature stored in the smart ring; and
in response to determining that the biometric feature sensed by the biometric sensor matches the biometric feature stored in the smart ring, enabling a function of the smart ring.

21. The method of claim 20, wherein the biometric sensor is configured to sense whether the smart ring is being inserted onto a finger, and wherein the biometric sensor is configured to sense the biometric feature in response to sensing that the smart ring is being inserted onto the finger.

22. The method of claim 21, wherein the biometric sensor is configured to sense whether the smart ring is being inserted onto the finger by detecting a tip of the finger.

23. The method of claim 21, wherein the biometric sensor is configured to sense whether the smart ring is being inserted onto the finger by detecting a contour of the finger.

24. The method of claim 20, wherein the biometric sensor is configured to sense whether the smart ring is being removed from a finger, and wherein the method further comprises disabling the function of the smart ring in response to determining that the smart ring is being removed from the finger.

25. The method of claim 24, wherein the biometric sensor is configured to sense whether the smart ring is being removed from the finger by detecting whether the smart ring was moved past a finger segment.

26. The method of claim 20, wherein the smart ring is configured to store a plurality of biometric features, each associated with a different function of the smart ring, and wherein the method further comprises:
determining which stored biometric feature matches the biometric feature sensed by the biometric sensor; and
enabling a function associated with the stored biometric feature that matches the biometric feature sensed by the biometric sensor.

27. The method of claim 26, wherein the plurality of biometric features are biometric features of different fingers of an individual user.

28. The method of claim 26, wherein the plurality of biometric features from different segments on a single finger.

29. The method of claim 20, wherein the function of the smart ring comprises at least one of the following: accessing user data stored in the memory, opening a door, making a payment, authenticating a secure application in a device in communication with the smart ring, controlling an application in a device in communication with the smart ring, and receiving an alert from a device in communication with the smart ring.

30. The method of claim 20, wherein the smart ring further comprises a wireless transceiver configured to perform the function.

31. The method of claim 20, wherein the smart ring further comprises a display device.

32. The method of claim 20, wherein the smart ring further comprises a battery.

33. The method of claim 20, wherein the biometric sensor is contoured along an inside surface of the ring body.

34. The method of claim 20, wherein the biometric sensor is contoured along an outside surface of the ring body.

35. The method of claim 20 further comprising storing the biometric feature of the authorized user in the memory during a set-up mode.

36. The method of claim 20, wherein the memory is a three-dimensional memory.

37. The method of claim 20, wherein the biometric sensor comprises a fingerprint sensor configured to sense a fingerprint.

38. The method of claim 20, wherein the biometric sensor is configured to sense one or more of the following: a finger vein, an oxygen saturation level, a pulse, and a heartbeat pattern.
